(19) United States
(12) Patent Application Publication
(10) Pub. No.: US 2026/0163734 A1
(43) Pub. Date: Jun. 11, 2026

(54) DATA TRANSFER USING A COMBINED IDENTIFIER

(71) Applicant: Apple Inc., Cupertino, CA (US)

(72) Inventors: Frank Andries van den Berg, San Jose, CA (US); Robin Burel, San Jose, CA (US); Rahul Narayan Singh, Santa Clara, CA (US)

(73) Assignee: Apple Inc., Cupertino, CA (US)

(21) Appl. No.: 19/381,289

(22) Filed: Nov. 6, 2025

Related U.S. Application Data
(60) Provisional application No. 63/729,053, filed on Dec. 6, 2024.

(51) Int. Cl. H04L 9/32; H04L 9/08

(52) U.S. Cl. CPC H04L 9/321; H04L 9/0861; H04L 9/3268

(57) ABSTRACT

A computer-implemented method that may include receiving a data transfer request to transfer data between an user account of an user associated with the user device and a third-party user account and receiving a first hashed token based at least in part on the data transfer request, generating a signed token by signing the first hashed token with a private key, generating a public key associated with the signed token, receiving an authorization request to authorize the data transfer request, generating a second hashed token by hashing the cryptogram and a second combined identifier stored by the processing server, extracting the first hashed token by decrypting the signed token with the public key, determining whether the second hashed token corresponds to the first hashed token, and performing a data transfer action between the user account to the third-party user account in accordance with the determination and the data transfer request.

### CROSS-REFERENCE TO RELATED APPLICATIONS

This application claims priority to U.S. Provisional Application No. 63/729,053, filed Dec. 6, 2024, the disclosure of which is incorporated by reference herein in its entirety.

### BACKGROUND

The development and advancement of wireless communication has led to the utilization of wireless communication for performing many tasks. One such task for which wireless communication has been utilized is the performance of data transfer between accounts. However, there are data security challenges in transferring data between accounts.

### BRIEF SUMMARY

One aspect of the disclosure provides for a computer-implemented method that may include receiving, by an application on an user device, a data transfer request to transfer data between an user account of an user associated with the user device and a third-party user account and receiving, by a service provider from an issuing device, a first hashed token based at least in part on the data transfer request. The first hashed token may include a cryptogram having transfer details of the data transfer request and a first combined identifier and the first combined identifier corresponds to a terminal identifier associated with a data terminal of the user device and a device identifier associated with the user device. The method may further include generating, by the service provider, a signed token by signing the first hashed token with a private key, generating, by the service provider, a public key associated with the signed token, receiving, by a processing server from the issuing device, an authorization request to authorize the data transfer request, where the authorization request may include the signed token, the public key and the cryptogram, generating, by the processing server, a second hashed token by hashing the cryptogram and a second combined identifier stored by the processing server, extracting, by the processing server, the first hashed token by decrypting the signed token with the public key, determining, by the processing server, whether the second hashed token corresponds to the first hashed token, and performing, by the application of the user device, a data transfer action between the user account to the third-party user account in accordance with the determination and the data transfer request.

Implementations may include one or more of the following features. The data transfer action may include initiating a transfer of data between the user account and the third-party user account in accordance with the determination that the second hashed token corresponds to the first hashed token and the data transfer request. The data transfer action may include canceling a transfer of data between the user account and the third-party user account in accordance with the determination that the second hashed token does not correspond to the first hashed token and the data transfer request. The data transfer action may include reversing a transfer of data between the user account and the third-party user account in accordance with the determination that the second hashed token does not correspond to the first hashed token and the data transfer request. The method may further include generating, by the user device, the first hashed token by hashing the cryptogram and the first combined identifier stored in the user device with a hashing algorithm, where the processing server generates the second hashed token with the hashing algorithm. The first combined identifier may additionally correspond to an user identifier associated with the user of the user device, and the method further may include generating, by the service provider, the first combined identifier by hashing the user identifier, the terminal identifier, and the device identifier. Generating the first combined identifier may include generating a certificate noting the generation of the first combined identifier. The method may further include, by the processing server, determining that the certificate is valid, and storing the first combined identifier, the user identifier and the terminal identifier. The method may further include determining that the certificate is valid includes extracting, from the certificate, the first combined identifier and signed certificate data, extracting, from the signed certificate data, a hashed combined identifier by decrypting the signed certificate data, generating a hashed value by hashing the first combined identifier, and determining that the hashed value corresponds to the hashed combined identifier.

One aspect of the disclosure provides for one or more non-transitory computer-readable media that may include computer-executable instructions that, when executed by one or more processors of a plurality of electronic devices, cause the one or more processors to perform operations that include receiving, by an application on an user device of the plurality of electronic devices, a data transfer request to transfer data between an user account of an user associated with the user device and a third-party user account and receiving, by a service provider of the plurality of electronic devices from an issuing device of the plurality of electronic devices, a first hashed token based at least in part on the data transfer request. The first hashed token may include a cryptogram having transfer details of the data transfer request and a first combined identifier and the first combined identifier corresponds a terminal identifier associated with a data terminal of the user device and a device identifier associated with the user device. The operations may further include generating, by the service provider, a signed token by signing the first hashed token with a private key, generating, by the service provider, a public key associated with the signed token, receiving, by a processing server of the plurality of electronic devices from the issuing device, an authorization request to authorize the data transfer request, where the authorization request may include the signed token, the public key and the cryptogram, generating, by the processing server, a second hashed token by hashing the cryptogram and a second combined identifier stored by the processing server, extracting, by the processing server, the first hashed token by decrypting the signed token with the public key, determining, by the processing server, whether the second hashed token corresponds to the first hashed token, and performing, by the application of the user device, a data transfer action between the user account to the third-party user account in accordance with the determination and the data transfer request.

Implementations may include one or more of the following features. The data transfer action may include initiating a transfer of data between the user account and the third-party user account in accordance with the determination that the second hashed token corresponds to the first hashed token and the data transfer request. The data transfer action may include canceling a transfer of data between the user account and the third-party user account in accordance with the determination that the second hashed token does not correspond to the first hashed token and the data transfer request. The data transfer action includes reversing a transfer of data between the user account and the third-party user account in accordance with the determination that the second hashed token does not correspond to the first hashed token and the data transfer request. The first combined identifier additionally corresponds to an user identifier associated with the user of the user device, and the operations further may include generating, by the service provider, the first combined identifier by hashing the user identifier, the terminal identifier, and the device identifier. Generating the first combined identifier may include generating a certificate noting the generation of the first combined identifier. The operations may further include, by the processing server, determining that the certificate is valid, and storing the first combined identifier, the user identifier and the terminal identifier.

One aspect of the disclosure provides for a system that includes a user device comprising a first memory comprising first computer-executable instructions and a first processor, a service provider comprising a second memory comprising second computer-executable instructions and a second processor, an issuing device comprising a third memory comprising third computer-executable instructions and a third processor, and a processing server comprising a fourth memory comprising fourth computer-executable instructions and a fourth processor, wherein the first processor, second process, and third process are configured to access the respective first memory, second memory, third memory and fourth memory, and execute the first computer-executable instructions, second computer-executable instructions, third computer-executable instructions and fourth computer-executable instructions to at least receive, by an application on the user device, a data transfer request to transfer data between a user account of a user associated with the user device and a third-party user account, receive, by the service provider from the issuing device, a first hashed token based at least in part on the data transfer request, where the first hashed token comprises a cryptogram comprising transfer details of the data transfer request and a first combined identifier, and the first combined identifier corresponds a terminal identifier associated with a data terminal of the user device and a device identifier associated with the user device, generate, by the service provider, a signed token by signing the first hashed token with a private key, generate, by the service provider, a public key associated with the signed token, receive, by a processing server from the issuing device, an authorization request to authorize the data transfer request, wherein the authorization request comprises the signed token, the public key and the cryptogram, generate, by the processing server, a second hashed token by hashing the cryptogram and a second combined identifier stored by the processing server, extract, by the processing server, the first hashed token by decrypting the signed token with the public key, determine, by the processing server, whether the second hashed token corresponds to the first hashed token, and perform, by the application of the user device, a data transfer action between the user account to the third-party user account in accordance with the determination and the data transfer request.

Implementations may include one or more of the following features. The data transfer action may include initiating a transfer of data between the user account and the third-party user account in accordance with the determination that the second hashed token corresponds to the first hashed token and the data transfer request. The data transfer action may include canceling a transfer of data between the user account and the third-party user account in accordance with the determination that the second hashed token does not correspond to the first hashed token and the data transfer request. The data transfer action may include reversing a transfer of data between the user account and the third-party user account in accordance with the determination that the second hashed token does not correspond to the first hashed token and the data transfer request.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram showing an example security device access environment, according to at least one example.

FIG. 2 illustrates a swim lane diagram showing example processes for registering a combined identifier, according to at least one example.

FIG. 3 illustrates a swim lane diagram showing example processes for transferring data using a combined identifier, according to at least one example.

FIG. 4 illustrates an example flowchart depicting a process for transferring data, according to at least one example.

FIG. 5 illustrates a simplified block diagram depicting an example architecture for implementing the techniques described herein, according to at least one example.

FIGS. 6A and 6B illustrate methods of application processes, in accordance with some embodiments.

FIG. 6C illustrates a device for implementing an API, in accordance with some embodiments.

FIG. 6D illustrates a system for implementing an API, in accordance with some embodiments.

FIGS. 6E and 6F illustrate data flows related to API processes, in accordance with some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, methods, systems, devices, and computer-readable media (collectively, “techniques”) for more securely transferring data associated with a user account. In particular, the present disclosure may allow a processing server to verify that identifiers (e.g., unique values associated with elements used in a data transfer) associated with devices previously registered with the processing server are not manipulated in a later data transfer. For example, a user may initiate a data transfer from a user account between a user device (e.g., a smart phone or other handheld and/or portable device) and a third-party account through an issuing device. The user device may generate a hashed token using a combined identifier-corresponding to a combination of identifiers associated with a user of the user device, a data terminal of the user device, and the user device itself-and a cryptogram including details of the data transfer request. The user device may encrypt the hashed token with a key shared between the user device and the service provider so that other entities, such as the issuing device, may not tamper with the hashed token. The service provider may receive the encrypted hashed token, decrypt the hashed token with the shared key, and sign the hashed token verifying that the hashed token has not been manipulated. The processing server may receive and decrypt this signed hashed token to extract the hashed token from the signed hashed token. The processing server may generate a separate hashed token with a separate combined identifier that was previously stored in a registration process. The processing server may then compare this extracted hashed token with the original hashed token generated by the processing server to determine whether the signed hashed token is valid (e.g., has not been manipulated) and whether to authorize the data transfer request. The processing server may decide how to process the data transfer according to this determination. This method can be beneficial where certain countries may include regulation that requires identifiers of users and devices in a data transfer to be registered and used in future data transfers for verification.

The systems, devices, and techniques described herein provide several technical advantages that improve the security of transferring data. Specifically, as data can be processed differently by the processing server according to the identifiers of the users in a data transfer process, verifying that the identifiers of the users used in a data transfer are not manipulated by malicious actors can be important to ensure that that the processing server accurately processes the data.

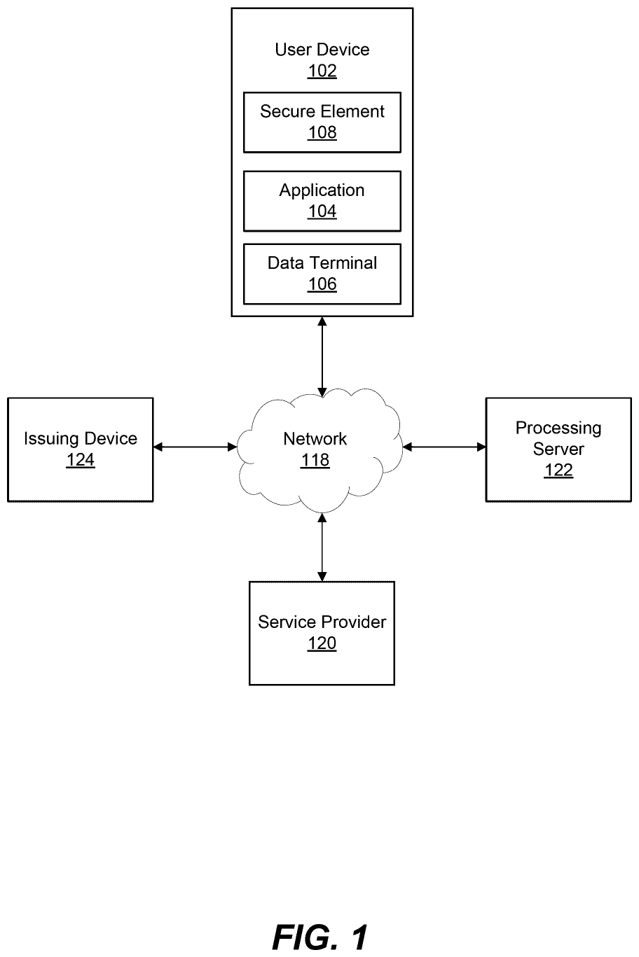

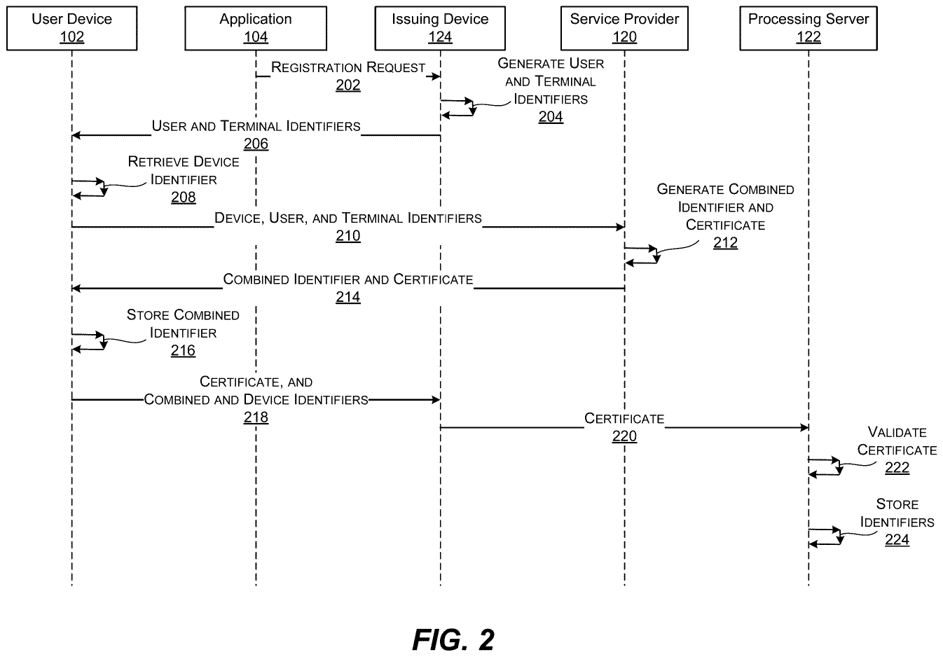

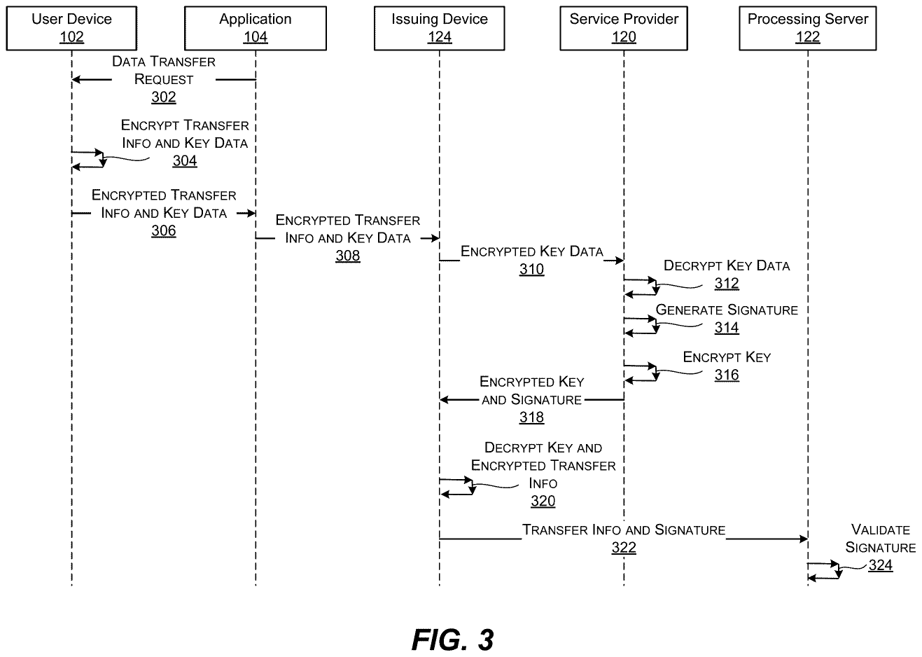

Turning now to the figures, FIG. 1 depicts a block diagram showing an example data transfer environment 100, according to at least one example. FIGS. 2 and 3 depict example flow diagrams showing data transfer processes using the data transfer environment 100, according to at least one example. The processes, and any other processes described herein, include operations that each can represent a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The data transfer environment 100 may include a user device 102, such as a cellular phone, a tablet computing device, a laptop computer, a watch-based computing device, or the like. The user device 102 may be associated with a user account that is, in turn, associated with a storage of data (e.g., a balance of funds, such as cash, credit, gift card, or the like). The user device 102 may be able to perform a data transfer (e.g., transfer of funds) to or from the user account.

The user device 102 may include a secure element 108 that stores sensitive information and can perform various operations (e.g., cryptographic operations) to facilitate data transfer processes. The secure element 108 may be associated with a device identifier specific to the user device 102. The secure element 108 may remain with the user device 102 for the lifespan of the user device 102. As such, the device identifier associated with the secure element 108 may correspondingly act as the device identifier associated with the user device 102.

The user device 102 may also include a data terminal 106 that acts as a point of interaction with another device (e.g., a third-party user device) for data transfer. Specifically, the data terminal 106 may initiate the data transfer to and from a user account associated with the user device 102. For example, the data terminal 106 can be used to transfer data between the user device 102 and a third-party user device, such as a contactless data transfer process (e.g., a contactless payment process) using a phone's communication hardware. For example, data may be transferred with the data terminal 106 using near field communication (NFC), Bluetooth® Low Energy (BLE), optical images (e.g., quick-response code, barcode, or the like), ultra-wideband (UWB), radio frequency identification (RFID), cellular networks, or the like. The data terminal 106 may be associated with a terminal identifier specific to the data terminal 106.

An application 104 may be installed in the user device 102 that can transmit information between the user device 102 and other devices, such as the issuing device 124, service provider 120, processing server 122, and/or third-party devices as discussed below. For example, a user may interact with the application 104 on the user device 102 to initiate various processes with other devices, such as a data transfer between the user device 102 and one or more third-party devices.

The user device 102 can communicate with a service provider 120 through a network 118 (e.g., the Internet, a wireless local area network, an Ethernet network, an intranet, an optical network, or other public or private network connection). The service provider 120 may include a computing device such as a server, a portion of a distributed computing device, or the like. For example, the service provider 120 can facilitate communications between devices as well as perform operations to increase the security of the data being transferred, as discussed below.

The service provider 120 may communicate with a processing server 122. The processing server 122 may include a computing device such as a server, a portion of a distributed computing device, or the like. For example, the processing server 122 may verify whether the identifiers of users and devices in a data transfer correspond to identifiers for those users and devices that were previously registered by the processing server 122. Additionally, the processing server 122 may process the transferred data according to whether the identifiers associated with the data transfer request are verified.

The service provider 120 may communicate with an issuing device 124. The issuing device 124 may include a computing device such as a server, a portion of a distributed computing device, or the like. The issuing device 124 may store and manage data of various user accounts, including the user account associated with the user device 102. For example, the issuing device 124 may be a financial institution, such as a bank, which can store, manage, and update the funds that are associated with a user account.

FIG. 2 is a swim lane diagram illustrating example techniques for registering identifiers using the data transfer environment 100 of FIG. 1 in accordance with at least one embodiment. A computing device comprising one or more processors and one or more computer-readable mediums (e.g., one or more memories) may be utilized. A computer-readable medium may store computer-executable instructions that, when executed by at least one processor, causes the computing device(s) to execute the operations of a method or other process. It should be appreciated that the operations of the may be performed in any suitable order, not necessarily the order depicted in FIG. 2. Further, the techniques may include additional, or fewer operations than those depicted in FIG. 2, and the operations may be performed in any order and/or in parallel. In some embodiments, the operations may be performed by any suitable device.

At step 202, the application 104 can transmit a registration request to the issuing device 124 associated with the user (e.g., a financial institution the user has an account with). to initiate the process, a user may interact with the application 104, such as providing information to log in to a user account, or creating a user account, with the application 104. The registration request may be a request for the issuing device 124 to register one or more of the user, the user account, and the user device 102 with the processing server 122.

At step 204, the issuing device 124 can generate a user identifier associated with the user/user account of the user device 102 and a terminal identifier associated with the data terminal 106 of the user device 102. The issuing device 124 can generate these identifiers according to information provided by the application 104, and which originated from the user providing information to the application 104, and/or according to information the issuing device 124 had previously stored from prior data transfers and/or interactions with the user.

At step 206, the issuing device 124 can transmit the user identifier and the terminal identifier to the user device 102. The issuing device 124 may transmit, with these identifiers, a registration communication indicating a desire to register the user device 102 with the processing server 122.

At step 208, the user device 102 can retrieve a device identifier associated with the user device 102. Specifically, the device identifier may be associated with the secure element 108 of the user device 102. In some embodiments, the user device may alternatively generate a device identifier associated with the user device that is not associated with the secure element. The user device 102 may retrieve the device identifier in response to the registration communication from the issuing device 124.

At step 210, the user device 102 can transmit the user identifier, the terminal identifier, and the device identifier to the service provider 120. The user device 102 may also transmit, with these identifiers, the registration communication to the service provider 120.

At step 212, the service provider 120 may generate a first combined identifier corresponding to the user identifier, the terminal identifier and the device identifier. However, in other examples, the service provider may generate the first combined identifier using less than all of the user identifier, the terminal identifier, and the device identifier. For example, the service provider may generate the first combined identifier using the terminal identifier and device identifier, and without the user identifier. The service provider 120 may generate the first combined identifier by hashing the user identifier, the terminal identifier and the device identifier together with a hashing algorithm. For example, the service provider 120 may generate the first combined identifier using a SHA-256 hashing algorithm. However, in other embodiments, other hashing algorithms may be used, such as algorithms in the SHA-1 family, SHA-2 family, SHA-3 family, a BLAKE hash function, or the like. As such, the first combined identifier may include a value specific to the combination of the user identifier, the terminal identifier and the device identifier provided to the service provider 120. After the first combined identifier is generated, the service provider 120 may also generate a script to inject the first combined identifier in another device, such as software to provision the first combined identifier to the user device 102. However, in some embodiments, the service provider may not generate a script.

The service provider 120 may generate certificate data by hashing the first combined identifier using a hashing algorithm noted above. In some embodiments, the certificate data may also include the user identifier, the terminal identifier, and the device identifier hashed with the first combined identifier. However, in other embodiments, the certificate data may not include the user identifier, the terminal identifier, and the device identifier hashed with the first combined identifier. Instead, the user identifier, the terminal identifier, and the device identifier may be provided in the certificate separate from the certificate data. In a yet further embodiment, the first combined identifier may also be provided in the certificate separate from the certificate data. The first combined identifier and the certificate may be generated in response to the registration communication provided by the user device 102.

Further, the certificate may include metadata regarding at least one of the generation of the first combined identifier, the generation of the certificate data, and signing of the certificate data. The metadata may additionally include an issuance date (e.g., the date the certificate was generated) and an expiration date (e.g., a future date on which the certificate expires corresponding to a length of time from the issuance date, such as six months, one year, two years, three years, or the like). In other embodiments, the issuance data and expiration date may be located in the certificate outside of the metadata. In yet other embodiments, the service provider may not generate a certificate.

In one example, the service provider 120 may store the certificate data in the certificate before signing the certificate. In this manner, recipients of the certificate may trust that the certificate data is valid within the certificate within an expiration period. In another example, rather than storing the certificate data in the certificate, the service provider 120 may generate a private certificate key to sign the certificate data for transmission separate as signed certificate data from the certificate and a public certificate key to be included in the certificate. In this manner, recipients of the certificate may trust that the public certificate key in the certificate is valid for use. As will be noted further below, the recipients of the certificate and certificate data can validate the certificate and extract the public certificate key. The recipients can then use the public certificate key to validate the signed certificate data. In this manner, the recipients of the certificate may trust that the certificate data is valid.

At step 214, the service provider 120 may transmit the first combined identifier, the script, and the certificate to the user device 102. As the certificate is signed, the user device 102 can trust that the certificate data is valid within the expiration date. In another example, where the certificate date is signed (e.g., using a private certificate key or the like) and not included as part of the certificate, the certificate may include a previously-generated public certificate key and the service provider 120 may transmit the signed certificate data separate from the certificate. In other embodiments, where the script is not generated, the service provider may transmit just the first combined identifier, the certificate, and the public certificate key to the user device.

At step 216, the user device 102 may store the first combined identifier as a second combined identifier. For example, the user device 102 may execute the script sent by the service provider 120 to inject the first combined identifier within the secure element 108 as a second combined identifier.

At step 218, the user device 102 may transmit the certificate, the first combined identifier, and the device identifier to the issuing device 124. In some examples, where the certificate date is signed and not included as part of the certificate, the user device 102 may transmit the certificate and separate signed certificate data to the issuing device 124. In other embodiments, where the certificate is not generated, the user device may transmit just the first combined identifier and the device identifier to the issuing device. In some embodiments, the issuing device 124 may store the first combined identifier and the device identifier for later use.

At step 220, the issuing device 124 may transmit the certificate to the processing server 122. In other embodiments, the issuing device may transmit the first combined identifier, the user identifier, the terminal identifier, and the device identifier to the processing server 122 in addition to, or instead of, the certificate (e.g., as a part of separate signed certificate data). In other embodiments, where the certificate does not include the user identifier or the terminal identifier, the issuing device may also transmit the user identifier and the terminal identifier to the processing server. The issuing device 124 may include, with the certificate, a request to register the first combined identifier, the user identifier, the terminal identifier, and the device identifier with the processing server 122.

At step 222, the processing server 122 may validate the certificate. In one example, where the certificate includes the certificate data, the processing server 122 may extract information from the certificate, such as the first combined identifier, the user identifier, the terminal identifier, the device identifier, the signed certificate data, the public certificate key, and the metadata. In another example, where the processing service 122 received signed certificate data separate from the certificate and the certificate includes a public certificate key, the processing server 122 can extract the public certificate key from the certificate to validate the signed certificate data. The processing server 122 may then extract the certificate data (e.g., the hashed first combined identifier generated by the user device 102) from the signed certificate data after validating the signed certificate data with the public certificate key. The processing server 122 may also generate a first hashed value by hashing the first combined identifier received with the certificate with the same hashing algorithm used to generate the certificate data and compare the certificate data with the first hashed value. However, in other embodiments, a different hashing algorithm may be used.

At step 224, the processing server 122 may store the identifiers. For example, if the first hashed value corresponds to the certificate data (e.g., if the first hashed value matches, or has the same value as, the certificate data, or the like), the processing server 122 may register the first combined identifier, the user identifier, the terminal identifier, and the device identifier by storing these identifiers in a database. The processing server 122 may register the user identifier as being associated with the user and/or the user account. The processing server 122 may register the terminal identifier as being associated with the data terminal 106. The processing server 122 may register the device identifier as being associated with the user device 102 and/or the secure element 108. The processing server 122 may register the first combined identifier as being associated with the combination of the user device 102 and/or the secure element 108, the user and/or the user account, and the data terminal 106.

The processing server 122 may send a success notification to the issuing device 124 indicating that the registration is successful. The issuing device 124 may send the success notification to the application 104 and the application 104 may send the success notification to the user device 102. If the first hashed value does not correspond to the certificate data, the processing server 122 may determine that the certificate is invalid, reject the request to register the identifiers, and send a failure notification back to the issuing device 124 indicating that the registration has failed. The issuing device 124 may send the failure notification to the application 104 the application 104 may send the failure notification to the user device 102, as noted above with the success notification. However, in other embodiments, the processing server may send also send the success/failure notification directly to the application and/or the user device. In some embodiments, the processing server and/or the issuing device may also send the success/failure notification to the service provider.

Additionally or alternatively, the processing server 122 may verify that the identifiers were not manipulated with prior to receipt by generating a third combined identifier to compare with the first combined identifier. Specifically, the processing server 122 may generate a third combined identifier by hashing the received user identifier, the terminal identifier, and the device identifier with the same hashing algorithm used by the service provider 120 to generate the first combined identifier. The processing server 122 may then generate a second hashed value by hashing the third combined identifier with the same hashing algorithm used by the service provider 120 to generate the certificate data and compare this second hashed value with the certificate data extracted from the signed certificate data. The processing server 122 may register or not register the identifiers (and send the corresponding notifications) according to whether the second hashed value corresponds to the certificate data, as noted above.

The processing server 122 may also check whether the certificate is expired. For example, the processing server 122 may check whether the date the processing server 122 received the certificate is before the expiration date. If so, and the identifiers are verified as noted above, the processing server 122 may register the identifiers and may transmit the success notifications, as described above. If not, the processing server 122 may not register the identifiers and may transmit the failure notifications, as described above.

FIG. 3 is a swim lane diagram illustrating example techniques for transferring data using the data transfer environment 100 of FIG. 1 in accordance with at least one embodiment. A computing device comprising one or more processors and one or more computer-readable mediums (e.g., one or more memories) may be utilized. A computer-readable medium may store computer-executable instructions that, when executed by at least one processor, causes the computing device(s) to execute the operations of a method or other process. It should be appreciated that the operations of the may be performed in any suitable order, not necessarily the order depicted in FIG. 3. Further, the techniques may include additional, or fewer operations than those depicted in FIG. 3, and the operations may be performed in any order and/or in parallel. In some embodiments, the operations may be performed by any suitable device.

In particular, once the first combined identifier, the user identifier, the terminal identifier, and the device identifier are registered, the processing server 122 may utilize these stored identifiers to verify future data transfers (e.g., future transactions or the like). To initiate the process, a user may interact with the application 104, such as initiating a data transfer request to transfer data transfer between the user account and a third-party user account (e.g., a transaction request between the user account and a third-party user account). The data in the data transfer request may involve the transfer of data stored by user accounts associated with the issuing device 124 and that are involved in the data transfer request, such as the user account associated with the user device 102.

At step 302, the application 104 may transmit the data transfer request to the user device 102. The user device 102 may receive transfer information from a third-party user device associated with the third-party account. For example, the transfer information may include a cryptogram associated with the data transfer request. The cryptogram may be a digital signature of the data transfer request that is unique to that data transfer request. In some examples, the cryptogram may be generated by the third-party user device. The cryptogram may include the transfer details of the data transfer request, such as the data to be transferred (e.g., amount of data, type of data, or the like), the date that the data transfer request was initiated, and the user accounts the data is being transferred between. In the context of a transaction, the cryptogram may include the amount of funds to be transferred, the date the transaction request was initiated, and the user accounts that the funds are being transferred between. The cryptogram may also include other metadata, such as the location of the devices or the like.

The transfer information may also separately include information about the third-party user account, such as the account identifier (e.g., account number or the like), third-party username, or the like. For example, the transfer information may include cardholder data, such as information related to a credit or debit card of the third-party user (e.g., the card number, name on the card, expiration date, credit card verification value, personal identification number, or the like). In some embodiments, rather than the cardholder data itself, the transfer information may include a tokenized or encrypted form of the cardholder data to minimize the risk that the cardholder data is accessible by malicious parties.

At step 304, the user device 102 (e.g., the secure element 108 of the user device 102) may generate encrypted key data according to the data transfer request. For example, the user device 102 may first generate a first hashed token by hashing the second combined identifier stored by the user device 102 during the registration process with the cryptogram using a hashing algorithm described above (e.g., a SHA-256 hashing algorithm or the like). As the first hashed token includes both the second combined identifier and the cryptogram, the first hashed token can be a unique value specific to this particular data transfer request involving the user device 102 (e.g., the secure element 108), the user account involved in the data transfer, and the data terminal 106. The user device 102 may also generate a transfer key using a key generation algorithm. The user device 102 may generate an encrypted transfer information by encrypting the transfer information with the transfer key.

As noted above, it can be important that the identifiers corresponding to the data transfer request are not manipulated as the identifiers may be associated with other data (e.g., certain labels or categories) that can affect how the transferred data is processed. For example, having the identifiers manipulated can result in the transferred data being stored or used incorrectly by the processing server 122. In one example, certain of the identifiers, such as the user identifier and the terminal identifier, may be associated with certain processing fees according to what kind of merchant type that the user identifier and terminal identifier is associated with (e.g., a supermarket may include a smaller processing fee for transactions than a café). As such, a malicious entity (e.g., the issuing device 124) may tamper with the identifiers so that the transaction is processed with a merchant type that has a smaller transaction fee than the transaction involved in the data transfer request. The systems, devices, and techniques provided herein addresses this issue by encrypting these identifiers (e.g., the first hashed token) so that the identifiers cannot be manipulated until the identifiers can be verified and signed (e.g., by the service provider 120).

Specifically, the user device 102 may encrypt the first hashed token and the transfer key with a first shared key to generate an encrypted key data. The secure element 108 may retrieve the first shared key from a database or, in other embodiments, may generate the first shared key using a key generation algorithm. As will be noted below, the first shared key may be a key shared with another device, such as the service provider 120. In some embodiments, the secure element 108 may transmit the first shared key to the service provider 120 through a secure channel not accessible by other unauthorized devices other than the user device 102 and service provider 120. Encrypting the first hashed token may ensure that the data in the first hashed token, such as one or more of the identifiers, are not manipulated by other devices (e.g., the issuing device 124) until the first hashed token reaches the other device that has the first shared key.

At step 306, the user device 102 may transmit the encrypted transfer information and the encrypted key data to the application 104.

At step 308, the application 104 may transmit the encrypted transfer information and the encrypted key data to the issuing device 124.

At step 310, the issuing device 124 may transmit the encrypted key data to the service provider 120. At this stage, the issuing device 124 may store the encrypted transfer information for later use.

At step 312, the service provider 120 may decrypt the encrypted key data. For example, the service provider 120 may extract the first hashed token and transfer key by decrypting the encrypted key data with the first shared key. The service provider 120 may retrieve the first shared key from a database. In some embodiments, the service provider 120 may receive the first shared key from the secure element 108 through the secure channel noted above.

At step 314, the service provider 120 may generate a signature by signing the first hashed token. Specifically, the service provider 120 may generate and/or retrieve a private hash key to sign (e.g., encrypt) the first hashed token and generate a signed token, and a public hash key to be later used by another device (e.g., the processing server 122) to decrypt the signed token. In this manner, the signed token may be later decrypted by the public hash key to validate that the contents of the first hashed token have not been manipulated by other devices following the creation of the first signed hashed token.

At step 316, the service provider 120 may encrypt the transfer key with a second shared key to generate an encrypted key. The service provider 120 may retrieve the second shared key from a database or, in other embodiments, may generate the second shared key using a key generation algorithm. As will be noted below, the first shared key may be a key shared with another device, such as the issuing device 124. In some embodiments, the service provider 120 may transmit the second shared key to the issuing device 124 through a secure channel not accessible by other unauthorized devices other than the service provider 120 and issuing device 124. In other embodiments, the transfer key may not be encrypted.

At step 318, the service provider 120 may transmit the encrypted key, signed token, and the public hash key to the issuing device 124. Where the transfer key is not encrypted, the service provider 120 transmits the transfer key to the issuing device 124.

At step 320, the issuing device 124 may decrypt the encrypted key and encrypted transfer information. For example, the issuing device 124 may extract the transfer key by decrypting the encrypted key with the second shared key. The issuing device 124 may retrieve the second shared key from a database or receive the second shared key from the secure element 108 through the secure channel noted above. The issuing device 124 may then extract the transfer information from the encrypted transfer information by decrypting the encrypted transfer information with the transfer key.

At step 322, the issuing device 124 may transmit the transfer information, the signed token, and the public hash key to the processing server 122 with an authorization request requesting. The authorization request may request that the processing server 122 authorize the data transfer of the data transfer request according to the details of the requested transfer noted in the transfer information (e.g., the details noted in the cryptogram, transfer information, or the like). The issuing device 124 may also transmit, to the processing server 122, the user identifier and the terminal identifier generated during the initial registration process.

Additionally, the issuing device 124 may also transmit the first combined identifier stored by the issuing device 124 during the initial registration process. However, in other embodiments, the issuing device may receive the second combined identifier from the user device and/or application, and transmit that received second combined identifier to the processing server instead. In another embodiment, the application may receive the second combined identifier from the user device and transmit the second combined identifier to the processing server instead of the issuing device.

At step 324, the processing server 122 may validate the signed token and determine whether the data transfer request is authorized. Although the processing server 122 may trust that the contents of the signed token have not been manipulated due to the service provider 120 signing the contents of the signed token, the processing server 122 can also perform an independent verification of the signed token. For example, the processing server 122 may generate a second hashed token to compare with the first hashed token in the signed token. As the hashed tokens incorporate the cryptogram of the data transfer request, this comparison has the added benefit of ensuring that the comparison of the hashed tokens is specific to this particular data transfer request (e.g., the data transfer request associated with the cryptogram) rather than a comparison of values that include another cryptogram for another data transfer request.

Specifically, the processing server 122 may retrieve the cryptogram of the data transfer request from the transfer information. The processing server 122 may generate a second hashed token by hashing the first combined identifier stored by the processing server 122 during the registration process and the cryptogram. The processing server 122 may use the same hashing algorithm in generating the second hashed token as the hashing algorithm the user device 102 used when generating the first hashed token. However, in other embodiments, a different hashing algorithm may be used. The processing server 122 may extract the first hashed token from the signed token by decrypting the signed token with the public hash key.

To validate the signed token and to determine whether to authorize the data transfer request, the processing server 122 may compare the first hashed token with the second hashed token to determine if the first hashed token corresponds to the second hashed token. In particular, the processing server 122 may know that the second combined identifier of the first hashed token has not been manipulated if the values of the first and second hash tokens correspond with each other (e.g., match) as any tampering of the identifiers in the first hashed token would result in the first hashed token having a different value than the second hashed token. If the first hashed token matches the second hashed token (e.g., has a same value), the processing server 122 may determine that the signed token is valid and that the data transfer request is authorized. However, if the values of the first and second hash tokens do not match, then the processing server 122 can determine that at least one of identifier provided to the processing server 122 in regard to the data transfer request has been manipulated. If the first hashed token and the second hashed token do not match, the processing server 122 may determine that the signed token is invalid and that the data transfer request is not authorized.

Additionally or alternatively, where the issuing device 124 provides the second combined identifier to the processing server 122, the processing server 122 may determine whether the data transfer request is authorized by determining whether the second combined identifier provided by the issuing device 124 corresponds to (e.g., matches) the first combined identifier stored by the processing server 122 during the registration process. For example, if the second combined identifier corresponds to the first combined identifier, the processing server 122 may trust that the data transfer request includes the user identifier, device identifier, and terminal identifier corresponding to the registered identifiers forming the first combined identifier. In some embodiments, the processing server 122 may additionally compare the user identifier and/or terminal identifier provided by the issuing device 124 with the corresponding user identifier and/or terminal identifier stored by the processing server 122 during the registration process to similarly determine whether data transfer request is authorized.

The user device 102, the application 104, and/or the service provider 120 may perform a data transfer action according to whether the first signed token is valid and whether the data transfer request is authorized. Additionally, the data transfer action may correspond to whether the data transfer has already occurred by the time that the processing server 122 makes this determination.

For example, if the processing server 122 determines that the first signed token is valid and the data transfer request is authorized, and the data has not yet been transferred (e.g., in a transaction involving a debit card), the processing server 122 may approve initiation of the transfer of data between the user account and the third-party user account (e.g., initiate the transfer of funds) according to the transfer details in the transfer information. In this case, the processing server 122 may provide instructions to initiate the data transfer request to one or more of the issuing device 124, the application 104, and the user device 102. The user device 102, the application 104, and/or the service provider 120 may initiate the transfer of data between the user account and the third-party user account according to the data transfer request.

If the processing server 122 determines that the first signed token is valid and the data transfer request is authorized, and the data has already been transferred (e.g., in a transaction involving a credit card), the processing server 122 may send a notification to one or more of the issuing device 124, the application 104, and the user device 102 that the data transfer is authorized while leaving the data transfer unchanged.

However, if the processing server 122 determines that the first signed token is not valid and the data transfer request is not authorized, and the data has not yet been transferred, the processing server 122 may send instructions to cancel the transfer of data (e.g., cancel the transaction) between the user account and the third-party user account. In this example, the processing server 122 may provide instructions to cancel the data transfer request to one or more of the issuing device 124, the application 104, and the user device 102. The user device 102, the application 104, and/or the service provider 120 may then cancel the data transfer request.

If the processing server 122 determines that the first signed token is not valid and the data transfer request is not authorized, and the data has already been transferred, the processing server 122 may instruct the application 104 to reverse the transfer of data between the user account and the third-party user account (e.g., reverse the transfer of funds made with the transaction). In this example, the processing server 122 may provide instructions to reverse the transfer of data to one or more of the issuing device 124, the application 104, and the user device 102. The user device 102, the application 104, and/or the service provider 120 may then reverse the data transfer.

The processing server 122 may additionally or alternatively transmit a success or failure notification to one or more of the issuing device 124, the application 104, the user device 102, and the service provider 120 of the determination of the validity of the first signed token and the authorization of the data transfer request. The processing server 122 may also send a notification to one or more of the issuing device 124, the application 104, the user device 102, and the service provider 120 regarding what data transfer action occurred following the above determination.

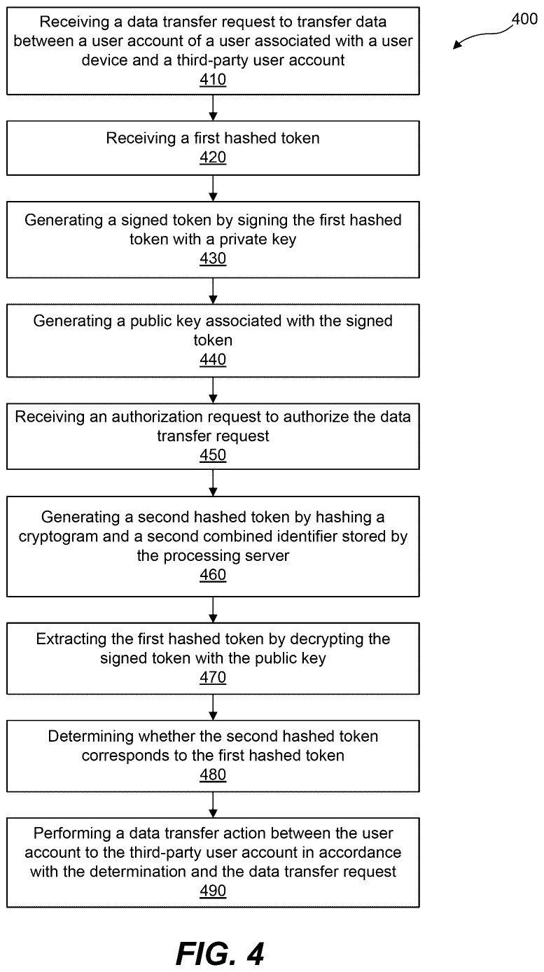

FIG. 4 depicts an example flowchart showing a process 400 for transferring data. Unless noted otherwise, the process 400 will be performed by the electronic devices noted in the data transfer environment 100.

At block 410, the application 104 on the user device 102 can receive a data transfer request to transfer data between a user account of a user associated with the user device and a third-party user account. For example, a user may interact with the application 104 to initiate the data transfer request to transfer data transfer between the user account and a third-party user account.

At block 420, the service provider 120 may receive from the issuing device 124 a first hashed token based at least in part on the data transfer request. The first hashed token may include a cryptogram having transfer details of the data transfer request and a first combined identifier. The first combined identifier may correspond to a user identifier associated with the user of the user device, a terminal identifier associated with a data terminal of the user device, and a device identifier associated with the user device. For example, the user device 102 may retrieve a combined identifier stored by the user device 102 during the registration process (e.g., the second combined identifier, as referenced in step 216 of FIG. 2). This combined identifier may be a hashed value of a user identifier corresponding to the user/user account of the user device 102, a terminal identifier corresponding to the data terminal 106, and a device identifier corresponding to the secure element 108. The user device 102 may generate the first hashed token by hashing this combined identifier with the cryptogram received in the transfer information from the third-party user device. This hashed token may be transmitted, as a part of the encrypted key data, from the user device 102 to the application 104, from the application 104 to the issuing device 124, and from the issuing device 124 to the service provide 120. The service provider 120 may extract the first hashed token by decrypting the encrypted key data with a first shared key that is shared between the service provider 120 and the user device 102.

At block 430, the service provider 120 may generate a signed token by signing the first hashed token with a private key. For example, the service provider 120 may generate and/or retrieve a private hash key to sign the first hashed token to generate the signed token.

At block 440, the service provider 120 may generate a public key associated with the signed token. For example, the public key may be a public hash key generated by the service provider 120 when the service provider 120 generated and/or retrieved the private hash key.

At block 450, the processing server 122 may receive from the issuing device 124, an authorization request to authorize the data transfer request. The authorization request can include the signed token, the public key, and the cryptogram. The cryptogram may be a part of the transfer information transmitted with the authorization request. The transfer information may be extracted by the issuing device 124 from the encrypted transfer information generated by the user device 102 by decrypting the encrypted transfer information with a transfer key generated by the user device 102.

At block 460, the processing server 122 may generate a second hashed token by hashing the cryptogram and a second combined identifier stored by the processing server. For example, the processing server 122 may generate the second hashed token by hashing the combined identifier stored during the registration process (e.g., the first combined identifier, as referenced in step 224 of FIG. 2) with the same hashing algorithm the user device 102 used to generate the first hashed token.

At block 470, the processing server 122 may extract the first hashed token by decrypting the signed token with the public key. For example, the processing server 122 may decrypt the first signed token with the public hash key generated by the service provider 120.

At block 480, the processing server 122 may determine whether the second hashed token corresponds to the first hashed token. For example, the processing server 122 may determine whether the second hashed token matches the first hashed token. If the hashed tokens match, the processing server 122 may determine that the signed token is valid and that the data transfer request is authorized. If the hashed tokens do not match, the processing server 122 may determine that the signed token is not valid and that the data transfer request is not authorized. Additionally or alternatively, the processing server may determine the validity of the signed token and whether the data transfer request is authorized based on whether the identifiers provided by the issuing device 124 with the authorization request matches the identifiers stored by the processing server 122 during registration of the identifiers. The processing server 122 may transmit instructions to the user device 102, the application 104, and/or the service provider 120 regarding the data transfer request according to the determination of validity for the sign token and the determination regarding whether the data transfer is authorized (e.g., the determinization of whether the first hashed token corresponds to the second hashed token).

At block 490, the application 104 of the user device 102 may perform a data transfer action between the user account to the third-party user account in accordance with the determination and the data transfer request. For example, the application 104 may be instructed by the processing server 122 to perform a certain data transfer action according to the determination of validity for the signed token and the determination regarding whether the data transfer is authorized, and whether the data has already been transferred or not. If the processing server 122 determines that the first signed token is valid and the data transfer request is authorized, and the data has not yet been transferred, the application 104 may initiate the transfer of data between the user account and the third-party user account according to the data transfer request. If the processing server 122 determines that the first signed token is not valid and the data transfer request is not authorized, and the data has not yet been transferred, the application 104 may cancel the data transfer request. If the processing server 122 determines that the first signed token is not valid and the data transfer request is not authorized, and the data has already been transferred, the application 104 may reverse the data transfer.

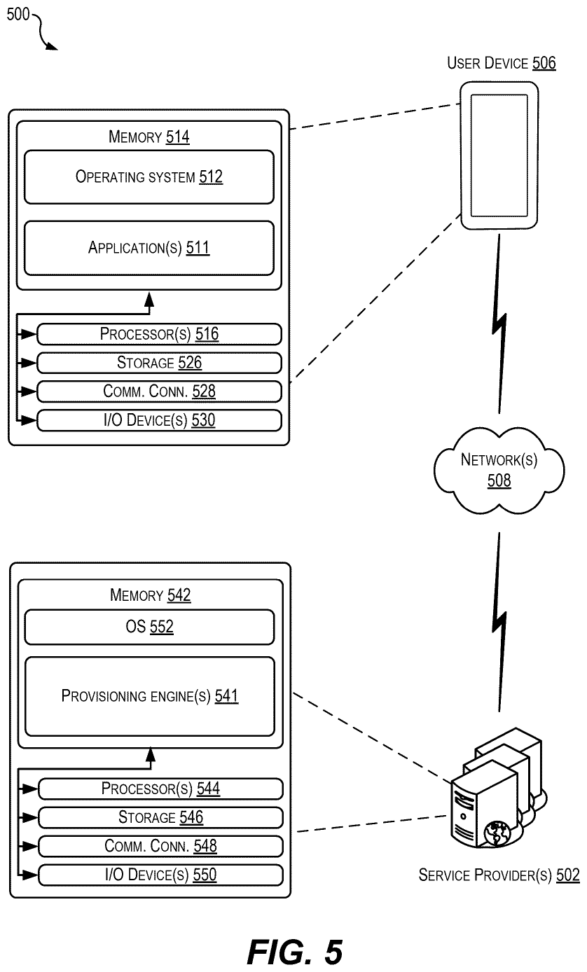

FIG. 5 illustrates an example architecture or environment 500 configured to implement techniques described herein, according to at least one example. In some examples, the example architecture or environment 500 may further be configured to enable a user device 506 and service provider computer 502 to share information. The service provider computer 502 is an example of the service provider 120. The user device 506 is an example of the user device 102. In some examples, the devices may be connected via one or more networks 508 (e.g., via Bluetooth, WiFi, the Internet, or the like). In some examples, the service provider computer 502 may be configured to implement at least some of the techniques described herein with reference to the user device 506.

In some examples, the networks 508 may include any one or a combination of many different types of networks, such as cable networks, the Internet, wireless networks, cellular networks, satellite networks, other private and/or public networks, or any combination thereof. While the illustrated example represents the user device 506 accessing the service provider computer 502 via the networks 508, the described techniques may equally apply in instances where the user device 506 interacts with the service provider computer 502 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer configurations, etc.).

As noted above, the user device 506 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 506 may be in communication with the service provider computer 502 via the network 508, or via other network connections.

In one illustrative configuration, the user device 506 may include at least one memory 514 and one or more processing units (or processor(s)) 516. The processor(s) 516 may be implemented as appropriate in hardware, computer-executable instructions, firmware, or combinations thereof. Computer-executable instruction or firmware implementations of the processor(s) 516 may include computer-executable or machine-executable instructions written in any suitable programming language to perform the various functions described. The user device 506 may also include geo-location devices (e.g., a global positioning system (GPS) device or the like) for providing and/or recording geographic location information associated with the user device 506.

The memory 514 may store program instructions that are loadable and executable on the processor(s) 516, as well as data generated during the execution of these programs. Depending on the configuration and type of the user device 506, the memory 514 may be volatile (such as random-access memory (RAM)) and/or non-volatile (such as read-only memory (ROM), flash memory, etc.). The user device 506 may also include additional removable storage and/or non-removable storage 526 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 514 may include multiple different types of memory, such as static random-access memory (SRAM), dynamic random-access memory (DRAM), or ROM. While the volatile memory described herein may be referred to as RAM, any volatile memory that would not maintain data stored therein once unplugged from a host and/or power would be appropriate.

The memory 514 and the additional storage 526, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 514 and the additional storage 526 are both examples of non-transitory computer storage media. Additional types of computer storage media that may be present in the user device 506 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 506. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 506 may also contain communications connection(s) 528 that allow the user device 506 to communicate with a data store, another computing device or server, user terminals, and/or other devices via the network 508. The user device 506 may also include I/O device(s) 530, such as a keyboard, a mouse, a pen, a voice input device, a touch screen input device, a display, speakers, a printer, etc.

Turning to the contents of the memory 514 in more detail, the memory 514 may include an operating system 512 and/or one or more application programs or services for implementing the features disclosed herein such as applications 511 (e.g., digital wallet, third-party applications, browser application, etc.). In some examples, the service provider computer 502 may also include a health application to perform similar techniques as described with reference to the user device 506. Similarly, at least some techniques described with reference to the service provider computer 502 may be performed by the user device 506.

The service provider computer 502 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, a virtual machine instance, etc. In some examples, the service provider computer 502 may be in communication with the user device 506 via the network 508, or via other network connections.

In one illustrative configuration, the service provider computer 502 may include at least one memory 542 and one or more processing units (or processor(s)) 544. The processor(s) 544 may be implemented as appropriate in hardware, computer-executable instructions, firmware, or combinations thereof. Computer-executable instruction or firmware implementations of the processor(s) 544 may include computer-executable or machine-executable instructions written in any suitable programming language to perform the various functions described.

The memory 542 may store program instructions that are loadable and executable on the processor(s) 544, as well as data generated during the execution of these programs. Depending on the configuration and type of service provider computer 502, the memory 542 may be volatile (such as RAM) and/or non-volatile (such as ROM, flash memory, etc.). The service provider computer 502 may also include additional removable storage and/or non-removable storage 546 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 542 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 542 and the additional storage 546, both removable and non-removable, are both additional examples of non-transitory computer-readable storage media.

The service provider computer 502 may also contain communications connection(s) 548 that allow the service provider computer 502 to communicate with a data store, another computing device or server, user terminals and/or other devices via the network 508. The service provider computer 502 may also include I/O device(s) 550, such as a keyboard, a mouse, a pen, a voice input device, a touch input device, a display, speakers, a printer, etc.

Turning to the contents of the memory 542 in more detail, the memory 542 may include an operating system 552 and/or one or more application programs or services for implementing the features disclosed herein including a provisioning engine(s) 541.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

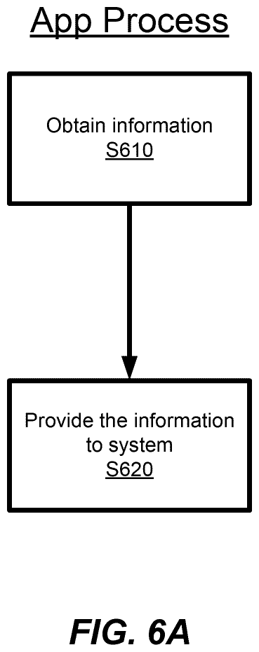

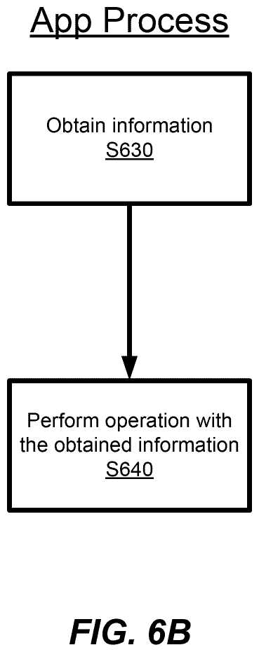

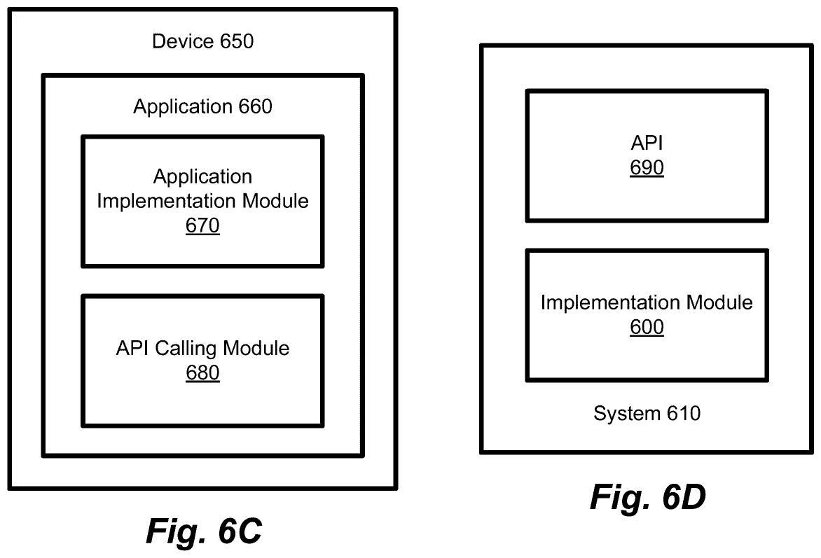

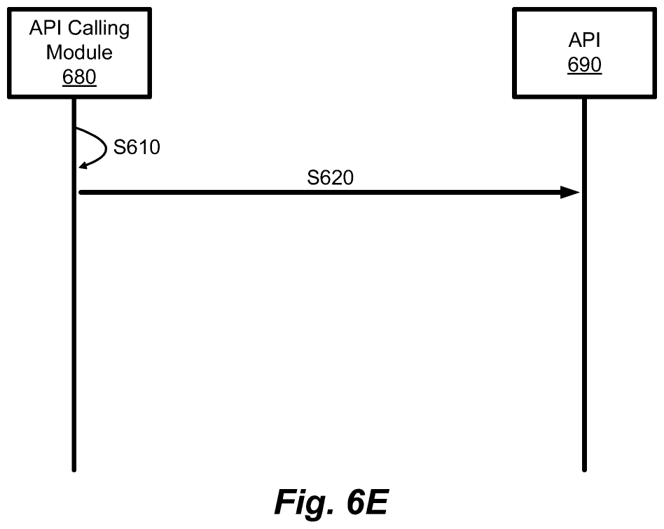

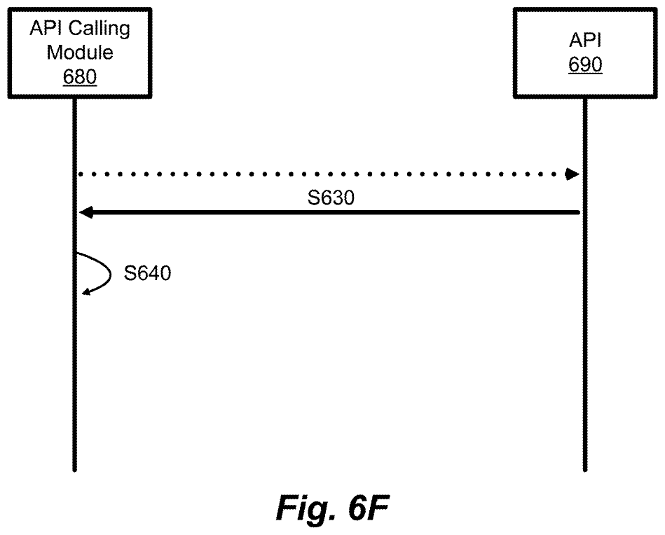

Implementations within the scope of the present disclosure include a computer-readable storage medium that encodes instructions organized as an application (e.g., application 660) that, when executed by one or more processing units, control an electronic device (e.g., device 650) to perform the method of FIG. 6B, the method of FIG. 6C, and/or one or more other processes and/or methods described herein.

It should be recognized that application 660 (shown in FG. 6D) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 660 is an application that is pre-installed on device 650 at purchase (e.g., a first party application). In other embodiments, application 660 is an application that is provided to device 650 via an operating system update file (e.g., a first party application or a second party application). In other embodiments, application 660 is an application that is provided via an application store. In some embodiments, the application store can be an application store that is pre-installed on device 650 at purchase (e.g., a first party application store). In other embodiments, the application store is a third-party application store (e.g., an application store that is provided by another application store, downloaded via a network, and/or read from a storage device).

Referring to FIG. 6B and FIG. 6F, application 660 obtains information (e.g., S710). In some embodiments, at S710, information is obtained from at least one hardware component of the device 650. In some embodiments, at S710, information is obtained from at least one software module of the device 650. In some embodiments, at S710, information is obtained from at least one hardware component external to the device 650 (e.g., a peripheral device, an accessory device, a server, etc.). In some embodiments, the information obtained at S710 includes positional information, time information, notification information, user information, environment information, electronic device state information, weather information, media information, historical information, event information, hardware information, and/or motion information. In some embodiments, in response to and/or after obtaining the information at S710, application 660 provides the information to a system (e.g., S720).

In some embodiments, the system (e.g., 610 shown in FIG. 6E) is an operating system hosted on the device 650. In some embodiments, the system (e.g., 610 shown in FIG. 6E) is an external device (e.g., a server, a peripheral device, an accessory, a personal computing device, etc.) that includes an operating system.

Referring to FIG. 6C and FIG. 6G, application 660 obtains information (e.g., S730). In some embodiments, the information obtained at S730 includes positional information, time information, notification information, user information, environment information electronic device state information, weather information, media information, historical information, event information, hardware information and/or motion information. In response to and/or after obtaining the information at S730, application 660 performs an operation with the information (e.g., S740). In some embodiments, the operation performed at S740 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 610 based on the information.

In some embodiments, one or more steps of the method of FIG. 6B and/or the method of FIG. 6C is performed in response to a trigger. In some embodiments, the trigger includes detection of an event, a notification received from system 610, a user input, and/or a response to a call to an API provided by system 610.

In some embodiments, the instructions of application 660, when executed, control device 650 to perform the method of FIG. 6B and/or the method of FIG. 6C by calling an application programming interface (API) (e.g., API 690) provided by system 610. In some embodiments, application 660 performs at least a portion of the method of FIG. 6B and/or the method of FIG. 6C without calling API 690.

In some embodiments, one or more steps of the method of FIG. 6B and/or the method of FIG. 6C includes calling an API (e.g., API 690) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 6D, device 650 is illustrated. In some embodiments, device 650 is a personal computing device, a smart phone, a smart watch, a fitness tracker, a head mounted display (HMD) device, a media device, a communal device, a speaker, a television, and/or a tablet. As illustrated in FIG. 6D, device 650 includes application 660 and operating system (e.g., system 610 shown in FIG. 6E). Application 660 includes application implementation module 670 and API calling module 680. System 610 includes API 690 and implementation module 600. It should be recognized that device 650, application 660, and/or system 610 can include more, fewer, and/or different components than illustrated in FIGS. 6D and 6E.

In some embodiments, application implementation module 670 includes a set of one or more instructions corresponding to one or more operations performed by application 660. For example, when application 660 is a messaging application, application implementation module 670 can include operations to receive and send messages. In some embodiments, application implementation module 670 communicates with API calling module to communicate with system 610 via API 690 (shown in FIG. 6E).

In some embodiments, API 690 is a software module (e.g., a collection of computer-readable instructions) that provides an interface that allows a different module (e.g., API calling module 680) to access and/or use one or more functions, methods, procedures, data structures, classes, and/or other services provided by implementation module 600 of system 610. For example, API-calling module 680 can access a feature of implementation module 600 through one or more API calls or invocations (e.g., embodied by a function or a method call) exposed by API 690 and can pass data and/or control information using one or more parameters via the API calls or invocations. In some embodiments, API 690 allows application 660 to use a service provided by a Software Development Kit (SDK) library. In other embodiments, application 660 incorporates a call to a function or method provided by the SDK library and provided by API 690 or uses data types or objects defined in the SDK library and provided by API 690. In some embodiments, API-calling module 680 makes an API call via API 690 to access and use a feature of implementation module 600 that is specified by API 690. In such embodiments, implementation module 600 can return a value via API 690 to API-calling module 680 in response to the API call. The value can report to application 660 the capabilities or state of a hardware component of device 650, including those related to aspects such as input capabilities and state, output capabilities and state, processing capability, power state, storage capacity and state, and/or communications capability. In some embodiments, API 690 is implemented in part by firmware, microcode, or other low-level logic that executes in part on the hardware component.

In some embodiments, API 690 allows a developer of API-calling module 680 (which can be a third-party developer) to leverage a feature provided by implementation module 600. In such embodiments, there can be one or more API-calling modules (e.g., including API-calling module 680) that communicate with implementation module 600. In some embodiments, API 690 allows multiple API-calling modules written in different programming languages to communicate with implementation module 600 (e.g., API 690 can include features for translating calls and returns between implementation module 600 and API-calling module 680) while API 690 is implemented in terms of a specific programming language. In some embodiments, API-calling module 680 calls APIs from different providers such as a set of APIs from an OS provider, another set of APIs from a plug-in provider, and/or another set of APIs from another provider (e.g., the provider of a software library) or creator of the another set of APIs.

Examples of API 690 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 650. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 600 is a system (e.g., operating system, server system) software module (e.g., a collection of computer-readable instructions) that is constructed to perform an operation in response to receiving an API call via API 690. In some embodiments, implementation module 600 is constructed to provide an API response (via API 690) as a result of processing an API call. By way of example, implementation module 600 and API-calling module 180 can each be any one of an operating system, a library, a device driver, an API, an application program, or other module. It should be understood that implementation module 600 and API-calling module 680 can be the same or different type of module from each other. In some embodiments, implementation module 600 is embodied at least in part in firmware, microcode, or other hardware logic.

In some embodiments, implementation module 600 returns a value through API 690 in response to an API call from API-calling module 680. While API 690 defines the syntax and result of an API call (e.g., how to invoke the API call and what the API call does), API 690 might not reveal how implementation module 600 accomplishes the function specified by the API call. Various API calls are transferred via the one or more application programming interfaces between API-calling module 680 and implementation module 600. Transferring the API calls can include issuing, initiating, invoking, calling, receiving, returning, and/or responding to the function calls or messages. In other words, transferring can describe actions by either of API-calling module 680 or implementation module 600. In some embodiments, a function call or other invocation of API 690 sends and/or receives one or more parameters through a parameter list or other structure.

In some embodiments, implementation module 600 provides more than one API, each providing a different view of or with different aspects of functionality implemented by implementation module 600. For example, one API of implementation module 600 can provide a first set of functions and can be exposed to third party developers, and another API of implementation module 600 can be hidden (e.g., not exposed) and provide a subset of the first set of functions and also provide another set of functions, such as testing or debugging functions which are not in the first set of functions. In some embodiments, implementation module 600 calls one or more other components via an underlying API and thus be both an API calling module and an implementation module. It should be recognized that implementation module 600 can include additional functions, methods, classes, data structures, and/or other features that are not specified through API 690 and are not available to API calling module 680. It should also be recognized that API calling module 680 can be on the same system as implementation module 600 or can be located remotely and access implementation module 600 using API 690 over a network. In some embodiments, implementation module 600, API 690, and/or API-calling module 680 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 600 (FIG. 6) is performed at a first computer system (as described herein) via a system process (e.g., an operating system process, a server system process) that is different from one or more applications executing and/or installed on the first computer system.

In some embodiments, process 600 (FIG. 6) is performed at a first computer system (as described herein) by an application that is different from a system process. In some embodiments, the instructions of the application, when executed, control the first computer system to perform process 600 (FIG. 6) by calling an application programming interface (API) provided by the system process. In some embodiments, the application performs at least a portion of process 600 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the method shown in FIG. 6 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 690 defines a first API call that can be provided by API calling module 690. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 650) that runs the application. In some embodiments, the implementation module is included in an electronic device that is separate from the device that runs the application.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The various examples further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C # or C++, or any scripting language, such as Perl, Python or TCL, as well as combinations thereof. The server(s) may also include database servers, including without limitation those commercially available from Oracle®, Microsoft® Sybase®, and IBM®.

The environment can include a variety of data stores and other memory, and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user's personal record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's personal health record. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method comprising:
receiving, by an application on a user device, a data transfer request to transfer data between a user account of a user associated with the user device and a third-party user account;
receiving, by a service provider from an issuing device, a first hashed token based at least in part on the data transfer request, wherein:
the first hashed token comprises a cryptogram comprising transfer details of the data transfer request and a first combined identifier; and
the first combined identifier corresponds to a terminal identifier associated with a data terminal of the user device and a device identifier associated with the user device;
generating, by the service provider, a signed token by signing the first hashed token with a private key;
generating, by the service provider, a public key associated with the signed token;
receiving, by a processing server from the issuing device, an authorization request to authorize the data transfer request, wherein the authorization request comprises the signed token, the public key and the cryptogram;
generating, by the processing server, a second hashed token by hashing the cryptogram and a second combined identifier stored by the processing server;
extracting, by the processing server, the first hashed token by decrypting the signed token with the public key;
determining, by the processing server, whether the second hashed token corresponds to the first hashed token; and
performing, by the application of the user device, a data transfer action between the user account to the third-party user account in accordance with the determination and the data transfer request.

2. The method of claim 1, wherein the data transfer action includes initiating a transfer of data between the user account and the third-party user account in accordance with the determination that the second hashed token corresponds to the first hashed token and the data transfer request.

3. The method of claim 1, wherein the data transfer action includes canceling a transfer of data between the user account and the third-party user account in accordance with the determination that the second hashed token does not correspond to the first hashed token and the data transfer request.

4. The method of claim 1, wherein the data transfer action includes reversing a transfer of data between the user account and the third-party user account in accordance with the determination that the second hashed token does not correspond to the first hashed token and the data transfer request.

5. The method of claim 1, further comprising generating, by the user device, the first hashed token by hashing the cryptogram and the first combined identifier stored in the user device with a hashing algorithm, wherein the processing server generates the second hashed token with the hashing algorithm.

6. The method of claim 1, wherein the first combined identifier additionally corresponds to a user identifier associated with the user of the user device, and the method further comprises generating, by the service provider, the first combined identifier by hashing the user identifier, the terminal identifier, and the device identifier.

7. The method of claim 6, wherein generating the first combined identifier includes generating a certificate noting the generation of the first combined identifier.

8. The method of claim 7, further comprising, by the processing server:
determining that the certificate is valid; and
storing the first combined identifier, the user identifier, and the terminal identifier.

9. The method of claim 8, wherein determining that the certificate is valid includes:
extracting, from the certificate, the first combined identifier and signed certificate data;
extracting, from the signed certificate data, a hashed combined identifier by decrypting the signed certificate data;
generating a hashed value by hashing the first combined identifier; and
determining that the hashed value corresponds to the hashed combined identifier.

10. One or more non-transitory computer-readable media comprising computer-executable instructions that, when executed by one or more processors of a plurality of electronic devices, cause the one or more processors to perform operations comprising:
receiving, by an application on a user device of the plurality of electronic devices, a data transfer request to transfer data between a user account of a user associated with the user device and a third-party user account;
receiving, by a service provider of the plurality of electronic devices from an issuing device of the plurality of electronic devices, a first hashed token based at least in part on the data transfer request, wherein:
the first hashed token comprises a cryptogram comprising transfer details of the data transfer request and a first combined identifier; and
the first combined identifier corresponds a terminal identifier associated with a data terminal of the user device and a device identifier associated with the user device;
generating, by the service provider, a signed token by signing the first hashed token with a private key;
generating, by the service provider, a public key associated with the signed token;
receiving, by a processing server of the plurality of electronic devices from the issuing device, an authorization request to authorize the data transfer request, wherein the authorization request comprises the signed token, the public key and the cryptogram;
generating, by the processing server, a second hashed token by hashing the cryptogram and a second combined identifier stored by the processing server;
extracting, by the processing server, the first hashed token by decrypting the signed token with the public key;
determining, by the processing server, whether the second hashed token corresponds to the first hashed token; and
performing, by the application of the user device, a data transfer action between the user account to the third-party user account in accordance with the determination and the data transfer request.

11. The one or more non-transitory computer-readable media of claim 10, wherein the data transfer action includes initiating a transfer of data between the user account and the third-party user account in accordance with the determination that the second hashed token corresponds to the first hashed token and the data transfer request.

12. The one or more non-transitory computer-readable media of claim 10, wherein the data transfer action includes canceling a transfer of data between the user account and the third-party user account in accordance with the determination that the second hashed token does not correspond to the first hashed token and the data transfer request.

13. The one or more non-transitory computer-readable media of claim 10, wherein the data transfer action includes reversing a transfer of data between the user account and the third-party user account in accordance with the determination that the second hashed token does not correspond to the first hashed token and the data transfer request.

14. The one or more non-transitory computer-readable media of claim 10, wherein the first combined identifier additionally corresponds to a user identifier associated with the user of the user device, and the operations further comprise generating, by the service provider, the first combined identifier by hashing the user identifier, the terminal identifier, and the device identifier.

15. The one or more non-transitory computer-readable media of claim 14, wherein generating the first combined identifier includes generating a certificate noting the generation of the first combined identifier.

16. The one or more non-transitory computer-readable media of claim 15, further comprising, by the processing server:
determining that the certificate is valid; and
storing the first combined identifier, the user identifier, and the terminal identifier.

17. A system comprising:
a user device comprising a first memory comprising first computer-executable instructions and a first processor;
a service provider comprising a second memory comprising second computer-executable instructions and a second processor;
an issuing device comprising a third memory comprising third computer-executable instructions and a third processor; and
a processing server comprising a fourth memory comprising fourth computer-executable instructions and a fourth processor, wherein the first processor, second process, and third process are configured to access the respective first memory, second memory, third memory and fourth memory, and execute the first computer-executable instructions, second computer-executable instructions, third computer-executable instructions and fourth computer-executable instructions to at least:
receive, by an application on the user device, a data transfer request to transfer data between a user account of a user associated with the user device and a third-party user account;
receive, by the service provider from the issuing device, a first hashed token based at least in part on the data transfer request, wherein:
the first hashed token comprises a cryptogram comprising transfer details of the data transfer request and a first combined identifier; and
the first combined identifier corresponds a terminal identifier associated with a data terminal of the user device and a device identifier associated with the user device;
generate, by the service provider, a signed token by signing the first hashed token with a private key;
generate, by the service provider, a public key associated with the signed token;
receive, by a processing server from the issuing device, an authorization request to authorize the data transfer request, wherein the authorization request comprises the signed token, the public key and the cryptogram;
generate, by the processing server, a second hashed token by hashing the cryptogram and a second combined identifier stored by the processing server;
extract, by the processing server, the first hashed token by decrypting the signed token with the public key;
determine, by the processing server, whether the second hashed token corresponds to the first hashed token; and
perform, by the application of the user device, a data transfer action between the user account to the third-party user account in accordance with the determination and the data transfer request.

18. The system of claim 17, wherein the data transfer action includes initiating a transfer of data between the user account and the third-party user account in accordance with the determination that the second hashed token corresponds to the first hashed token and the data transfer request.

19. The system of claim 17, wherein the data transfer action includes canceling a transfer of data between the user account and the third-party user account in accordance with the determination that the second hashed token does not correspond to the first hashed token and the data transfer request.

20. The system of claim 17, wherein the data transfer action includes reversing a transfer of data between the user account and the third-party user account in accordance with the determination that the second hashed token does not correspond to the first hashed token and the data transfer request.
